(19) United States
(12) Patent Application Publication
(10) Pub. No.: US 2021/0380026 A1
(43) Pub. Date: Dec. 9, 2021

(54) METHOD AND ASSEMBLY FOR ENERGY ABSORPTION AS A PROTECTION FROM DAMAGE IN AN OVERLOAD EVENT

(71) Applicant: General Dynamics European Land Systems-Mowag GmbH, Kreuzlingen (CN)

(72) Inventor: Hans-Joerg List, Friedrichshafen (DE)

(21) Appl. No.: 17/283,759

(22) PCT Filed: Nov. 19, 2019
(86) PCT No.: PCT/EP2019/081816

§ 371 Date: Apr. 8, 2021

(30) Foreign Application Priority Data
Nov. 27, 2018 (DE) 10 2018 130 002.6

(51) Int. Cl. B60N 2/427; B60N 2/00; B60N 2/50; B60N 2/52

(52) U.S. Cl. CPC B60N 2/42709; B60N 2/002; B60N 2/4242; B60N 2/522; B60N 2/4279; B60N 2/501

(57) ABSTRACT

An assembly for absorbing energy in an overload event has an energy absorber for reducing the load on an object being transported on a loading unit. The energy absorber, in the case of a one-off overload event with an energy input that is sufficiently high that damage to the object would be possible or highly likely in the absence of the energy absorber, to absorb energy in order to reduce the load on the object. Measured values relating to the current state of the loading unit are periodically acquired by a sensor device. A control device identifies an overload event from the acquired measured values. A weight of the object to be transported and a limit value for a load on the object are determined. Following identification of the overload event, damping by the energy absorber is controlled to keep the load on the object below the limit value.

The present invention relates to a method for absorbing energy during an overload event using an energy absorber, in order to reduce loads on an object being transported on a loading unit. The energy absorber is suitable, at least during a single overload event which introduces such a high degree of energy that there is the possibility or an overwhelming likelihood that the object would be damaged without an energy absorber, for absorbing energy in such an amount as to reduce the resulting load on the object during the overload event, and to prevent permanent damage. Such a single overload event occurs for example when a mine detonates.

Different methods are known for absorbing energy in order to reduce loads during overload events, such as explosions underneath armoured vehicles, to protect the objects being transported, in particular persons and sensitive devices. Typically, mechanical systems are used for protection which absorb energy by being deformed or torn open in order to absorb energy and protect passengers correspondingly during an overload event. Hydraulic systems are also sometimes used.

However, their disadvantage is that with said systems it is impossible to control the damping or energy absorption during an overload event when its impulse intensity and progression are unknown.

WO 2015/136105 A1 has disclosed a method and an assembly for energy absorption of loads, acting in an overload event as a protection from damage, wherein, after detecting an overload event, the energy absorber is immediately set to the maximum damping value, so as to set the highest possible damping for a predetermined time interval from occurrence of the event. During the specified time period, a plurality of successive measurement values is captured, and after the specified time period the damping is controlled in dependence on the measurement values during the specified time period. This means that during the overload event, a plurality of measurement values is captured from which a prognosis is derived, which is used for the further controlling. The quality of this method is directly dependent on the quality of the measurement values and on the quality of the control device. High quality requires expensive sensors and a correspondingly expensive control device.

It is therefore the object of the present invention to provide a method and an assembly for damping, enabling good damping control during overload events, which method and assembly can be implemented with reduced overhead.

This object is solved by a method having the features of claim 1 and an assembly having the features of claim 18. Preferred specific embodiments of the invention are indicated in the sub-claims. Further advantages and features can be taken from the general description and the description of the exemplary embodiments.

A method according to the invention is used for absorbing energy during an overload event and is carried out in particular with an energy absorber. By absorbing energy, the load on an object being transported on a loading unit is reduced at least during an overload event. The energy absorber is in particular suitable to absorb energy during a single overload event involving such a high amount of energy being introduced that it is possible, probable, overwhelmingly probable or even almost certain or certain that absent an energy absorber, the object will be damaged, so that said energy absorption by the energy absorber reduces the load on (the loading unit respectively) an, or the, object resulting from the overload event, and in order to in particular prevent the object from being damaged. A sensor device periodically captures measurement values about the present state of the loading unit. A control device detects an overload event from the captured measurement values. A measure of the weight of the object in, or intended for, transport is determined. The measure of the weight serves to determine the threshold value for a load on the object intended for transport. Upon detection of an overload event, the damping of the energy absorber is controlled such that the load respectively the load value on the object intended for transport remains beneath the threshold value. To this end, upon detection of the overload event, the damping of the energy absorber is preferably periodically adjusted by way of the periodically captured measurement values, and the damping of the energy absorber is modified, in particular by way of the periodically captured measurement values.

The method according to the invention has many advantages. One considerable advantage consists in the fact that upon detection of an overload event, the damping is directly set, in dependence on the present measurement values. It is a particular advantage that the damping is set in dependence on the weight of the object intended for transport.

Preferably, the damping of the energy absorber is not only periodically set, but the damping of the energy absorber is regulated. Then, the control device may be denoted, or at least comprises, a regulating device. A system in which a characteristic parameter is determined at periodic intervals and damping is periodically adjusted in dependence on the determined parameter, may also be understood to mean regulation. It is also possible to perform active regulation.

According to this application, damage to an object is deemed to mean a state in which the object was or is at least temporarily altered in a way considered disadvantageous or undesirable. This may be a temporary damage. Permanent or irreparable damage are also conceivable.

If the object is a person, damage is deemed to mean incapacitation or impairment to health. In the case of a person, permanent damage is deemed to mean an at least prolonged impairment of the wellbeing thereof. Damage to an article or a device can be temporary, however, in particular, it is long-lasting and can also be a permanent defect, such as a fractured component.

The method considerably reduces the risk of injury to a transported person as the transported object. Since setting the damping requires taking into account the weight of a person intended for transport, the damping is set individually for the person intended for transport and their weight. This reliably prevents subjecting small persons to too high loads, since the spines of smaller and lighter persons show e.g. a smaller cross-sectional area, and due to their strength they cannot be exposed to the same high loads as do the spines of large and heavier persons, who typically show a larger cross section of the spine and thus also higher strength.

The method and the assembly are typically employed in armoured vehicles or for example speedboats or the like, which are manned by soldiers or police officers who tend to be physically fit. Thus, conclusions can be made to some degree about the stature of the transported person based on the weight. Individual adaptations of the threshold value are possible and preferred though.

The method according to the invention allows to achieve reliability of setting and controlling the damping in the case of overload events, wherein no complicated control device with a complex forecasting device is required. This reduces the overhead for using the method according to the invention or the assembly according to the invention, and the costs incurred.

The method according to the invention allows to make optimal use of the feasible movement paths in the case of particularly violent overload events, since suitable damping can be set individually for each person intended for transport or for each object intended for transport. This allows to achieve optimal protection for each single person. The damping can in particular be set to a very high value, while endeavoring to not exceed the individual threshold value for the person intended for transport.

If the sensor device is mounted to the seat of a person intended for transport, then the weight force of the transported person acts on the sensor device. In the case of a mine explosion, the cushion or seat cushion on which a user is seated is compressed first, before the spine of the transported person is compressed. Thus, the load onto the sensor device in the seat assembly is retarded. This means that the periodic setting of the damping by way of the periodically captured measurement values, implicitly takes into account the cushion and the physical characteristics of the transported person. The damping will be optimal at all times, without having to determine forecasts from the measurement values captured.

In a preferred specific embodiment, the control device periodically derives from the measurement values, characteristic parameters of loads respectively load values on the loading unit assembly. To this end, the measurement values can for example be converted to standard units by way of suitable factors, or dimensionless, characteristic values suitable for further processing can be determined.

Preferably, the load device is provided with a shear device or at least one shear device. The shear device shears off as the load acting on the loading unit exceeds an overload event threshold. The control device detects an overload event when shearing of the shear device is detected. An advantage of said shear device is that the vertical lift provided by the energy absorber is completely conserved until an overload event occurs. This leads to the entire vertical lift being available during an overload event, so that even large loads can be damped and their energy can be absorbed. Said embodiment is very easy to execute, since the shear device, such as a shear pin, being sheared can be used as a starting point for the method. As an example, the sensor device periodically records measurement values only when the shear sensor has detected the shear device being sheared. This can be done, as an example, by means of the shear pin providing a continuous, electrically conductive connection, the interruption of which initiates the starting signal for periodically recording measurement values. Alternately, a capacitive or inductive sensor is conceivable.

A shear device, as is a shear pin, is preferably matched to the lightest-weight person intended for transport. However, this may involve destruction of the shear pin by a heavyweight person even prior to the overload event. This is why continuous or periodic monitoring of the sensor data is advantageous. It is preferred for the control unit to detect an overload event as a characteristic parameter exceeds an overload event threshold. In simple configurations, an overload event is detected as a measurement value exceeds a corresponding threshold. Such a configuration works both with and without using a shear device. It is possible for the control device to constantly record measurement values from the sensor device and to detect the overload event by means of the value of the derived characteristic parameters (or directly of the measurement values). If the measured or detected acceleration of the seat assembly exceeds a certain value, or if the force applied exceeds a certain level, an overload event is detected.

It is particularly preferred to specify the overload event threshold in dependence on the (defined or individually specified) threshold value. The overload event threshold can for example be set to e.g. 50% or 60% or 75% of the threshold value. Such an individual overload event threshold offers the advantage that for example in a personnel carrier transporting a number of persons, the overload event threshold is set, and accordingly exceeded and individually detected, in individual dependence on each person. Thus, the loading factor of each individual person is optimally taken account of. In transporting instruments or other devices, specific individual overload event thresholds may be set, in relation to the delicacy of the instrument or device concerned. This applies in particular for example to transporting objects such as ammunition or explosives or their components.

In preferred specific embodiments, the measure of the weight of the object intended for transport is determined from the load on the loading unit in a state of rest (load value in a state of rest). Such determination is in particular done while the vehicle or the transport means is immobile. For example prior to starting the vehicle or setting it in motion.

In preferred specific embodiments the measure of the weight of the object intended for transport is determined from time-averaging the load (mean load value) on the loading unit. For example, prior to starting the transport means, the load may be measured for a specific time period, and a time average may be derived therefrom. Alternately it is possible to determine a time average of the load on the loading unit, during or after starting, or in operation. A time average of the load may be derived and employed for determining the individual overload event threshold, for example for 1 second or 5 seconds or 10 seconds, or for shorter or longer time periods.

The load on the loading unit is in particular determined immediately upon activation. Activation is in particular understood to mean, starting a transport means, or activation of the assembly.

In all the configurations it is preferred to determine the type of the object intended for transport. If the objects intended for transport are persons, the gender may in particular be determined. Alternately, the age or age group, or other characteristics may be determined. Preferably, an identification unit of the object intended for transport is detected. Preferably, a memory of the identification unit of the object intended for transport is read out, wire-bound or wireless. For example the data from the memory of the identification unit may be read via RFID (radio-frequency identification), Bluetooth, WLAN or other wire-bound or wireless processes. The memory may contain details about the gender, size, weight, and in particular also a personal threshold value for the object or the person intended for transport.

In all the configurations it is preferred for an individual factor for determining the threshold value, or a direct threshold value, to be incorporated. This allows appropriate controlling. The threshold value may for example be individually increased or decreased by a factor, such as entry by the user of e.g. 80% or 120%. Directly entering a threshold value is likewise conceivable.

In all the configurations it is preferred for the method to also allow comfort damping. It is in particular preferred to set a ratio, in particular predetermined or selectable, of a vertical lift of the energy absorber for comfort damping. For example, given a total vertical lift of 160 mm or 180 mm, a ratio of 30 mm, 40 mm, 50 mm, 60 mm or 70 mm may be provided for the comfort function. For example, a ratio of at least 10% of the total vertical lift may be provided for the comfort function. Preferably, a ratio of at least 15% or 20% is provided for the comfort function. Particularly preferred is a ratio of the total vertical lift between 10% and 50% and preferably between 20% and 35% of the total vertical lift.

Then, while riding for example in an armoured vehicle in open terrain, weaker (and heavier) hits and shocks may be damped, while at the same time sufficient vertical lift is provided so that in an unforeseen overload event such as a mine explosion the available vertical lift is still sufficient to reliably protect transported persons. The ratio of a vertical lift of the energy absorber for a comfort function is in particular adjustable.

It is also possible and preferred to increase damping in the comfort range as the actual vertical lift approaches the limit of the comfort range.

When employing a shear device it is possible and preferred for a shear unit such as a shear pin to not shear off before the limit of the comfort lift. In these cases, shearing off or severing a shear unit may be used as a trigger for detecting an overload event.

In preferred configurations, an overload event threshold and/or a maximum load on the object being transported is variable. The overload event threshold and/or the maximum load may be provided to increase or decrease proportionally, in percentages or in steps. This enables to achieve still better individual adaptation.

Preferably, a presetting for a maximum load is stored in the identification unit.

Particularly preferably the maximum load is dependent on the gender and/or the age of a person intended for transport. It is also possible for the maximum load to depend on the state of fitness or another specified or adjustable parameter of an object intended for transport.

In preferred specific embodiments the energy absorber is provided with an absorber valve, the damping of which is controlled by the strength of an applied magnetic field. The energy absorber in particular uses a magnetorheological fluid, which is under controlled influence via the strength of an applied magnetic field.

In all the configurations it is possible and preferred to provide a plurality of energy absorbers. The term “an energy absorber” is thus understood to mean at least one energy absorber. An energy absorber may comprise two or more energy absorber units. Each of the energy absorber units may preferably be identical in structure. At least one energy absorber unit may be configured as is an energy absorber described above. Two or more energy absorber units may be disposed adjacent to one another, or remote from one another. For example on, or in the vicinity of, the lateral ends of the loading unit, one energy absorber unit or one energy absorber each may be disposed. Two or more or preferably all of the energy absorber(s) (units) are preferably controlled jointly. Actuation occurs in particular (at least substantially) simultaneously, or in particular at least at an overlap in time.

An assembly according to the invention with a loading unit for transporting objects comprises an energy absorber or at least one energy absorber for absorbing energy at least during an overload event, in order to reduce loads acting on an object being transported on the loading unit. The energy absorber is configured and suitable for absorbing energy during a single overload event, which introduces such a high degree of energy that without an energy absorber, there is the possibility or overwhelming likelihood of damage to the object, in order to reduce, by means of the energy absorption of the energy absorber, the load (load value) on the object resulting from the overload event. A control device and at least one sensor device for detecting measurement values about the present state of the loading unit and at least the energy absorber are provided, wherein the energy absorber with the measurement values can be controlled by the control device. The control device is set up and configured to detect an overload event from the captured measurement values. The control device is set up and configured to determine the measure of the weight of the object intended for transport, and to determine from the measure of the weight, a threshold value for a load on the object intended for transport. The control device is set up and configured, upon detection of an overload event, to control the damping of the energy absorber so that the load (in particular a load value) of the object intended for transport remains beneath the threshold value. In particular is the control device set up and configured, at least upon detection of the overload event, to periodically adjust the adaptation of the damping of the energy absorber, respectively to adapt the damping, by means of the periodically captured measurement values.

The assembly according to the invention also has many advantages. The assembly according to the invention allows ease and reliability of controlling the damping in the case of an overload event, wherein a transported object, such as in particular a transported person or an article intended for transport, are reliably and optimally protected.

The assembly according to the invention preferably comprises a sensor device attached to the assembly. The sensor device may be coupled wire-bound or wireless, or wire-bound and wireless in combination. Redundant coupling is conceivable.

The sensor device is preferably attached to a dampened part of the assembly. It is for example preferred for the sensor device to be fastened to the seat assembly for example of a mine blast protection seat. The sensor device in particular determines directly or indirectly, a measure of the weight respectively a weight force of a person seated thereon.

Preferably the sensor device comprises at least one sensor such as a weighing cell and/or at least one expansion measuring strip and/or a load transducer and/or other sensor types and sensors, for detecting a force. These types of sensors allow to determine, or derive from the measurement values, values of the weight force or the load on a person intended for transport or an article intended for transport, by way of simple or complex conversions, integration, and/or differentiation.

In preferred specific embodiments the energy absorber is provided with at least one absorber valve, the damping of which is controlled by the strength of the magnetic field applied.

The loading unit is preferably provided with a shear device that can be sheared off when the load acting on the loading unit exceeds a specified value.

In all the configurations it is preferred for the assembly to comprise a loading unit, which is configured as a seat assembly on a transport means, such as a vehicle or for example a boat. The seat assembly comprises a receiving unit formed as a seat, and a carrier device formed as a seat frame. The energy absorber is disposed (at least functionally) between the seat and the seat frame.

Another or a different method serves for absorbing energy during an overload event using an energy absorber, in order to reduce loads on an object being transported on a loading unit. The energy absorber is suitable for absorbing energy at least during a single overload event, which introduces such a high degree of energy that without an energy absorber, there is an overwhelming likelihood of damage to the object. During the overload event, the energy absorption by the energy absorber causes reduction of a resulting load (resulting load value) on the object. A sensor device in particular periodically determines measurement values about the present state of the loading unit. A control device detects an overload event from the captured measurement values. A measure of the load (load value) of the object intended for transport is (periodically) determined. Upon detection of the overload event, damping of the energy absorber is controlled such that the load (load value) of the object intended for transport remains beneath the threshold value. The applicant reserves the right to claim separate protection for this method.

Another or a different assembly includes a loading unit for transporting objects and an energy absorber for absorbing energy at least during an overload event, in order to reduce loads on an object being transported on the loading unit. The energy absorber is suitable and set up to absorb energy in a single overload event involving energy input that is so high that absent an energy absorber, damage to the object transported on the loading unit is probable or overwhelmingly likely, so as to reduce resulting loads (resulting load values) acting on the object in the overload event by way of energy absorption by means of the energy absorber. A control device and at least one sensor device are provided in order to detect measurement values about the present state of the loading unit and at least of the energy absorber, wherein the energy absorber can be controlled by the control device by means of the measurement values. The control device is set up and configured to detect an overload event from the captured measurement values. The control device is set up and configured to determine the measure of a load on the object intended for transport. The control device is set up and configured, upon detection of the overload event, to control damping of the energy absorber such that the load (load value) on the object intended for transport remains beneath the threshold value. The applicant also reserves the right to claim separate protection for this assembly.

This method as just described, and this apparatus as just described, offer many advantages. The method is simple in carrying out and offers considerable protection. In specific embodiments of this method and this apparatus, individual, some or all of the features of the configurations described above, may be additionally realized.

Further advantages and features of the present invention can be seen from the description of the exemplary embodiments discussed below with reference to the attached figures.

The figures show in:

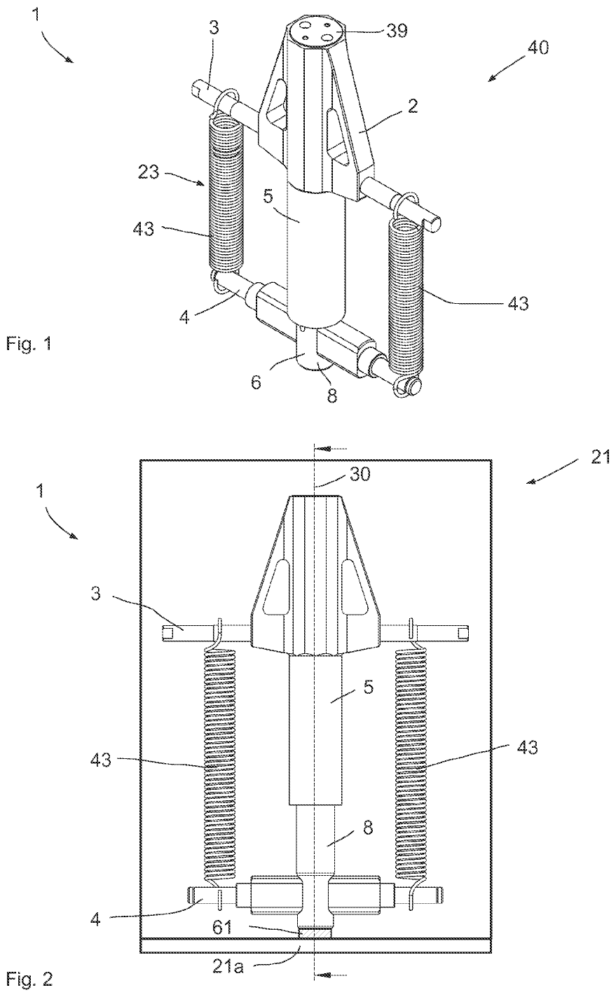

FIG. 1 a schematic, perspective view of an assembly according to the invention;

FIG. 2 a front view of the assembly according to FIG. 1;

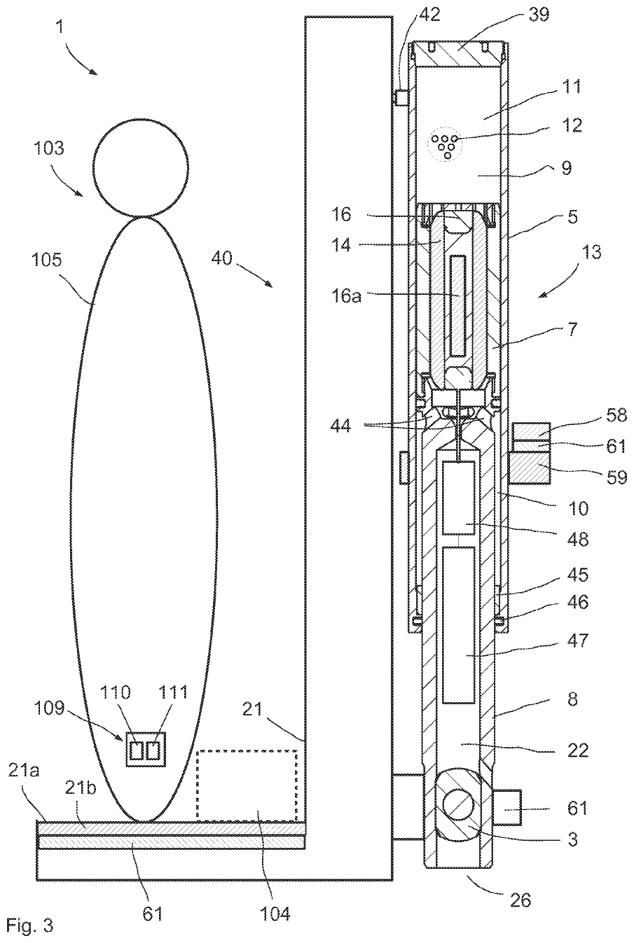

FIG. 3 a side sectional view of the assembly according to FIG. 1 in the damping state;

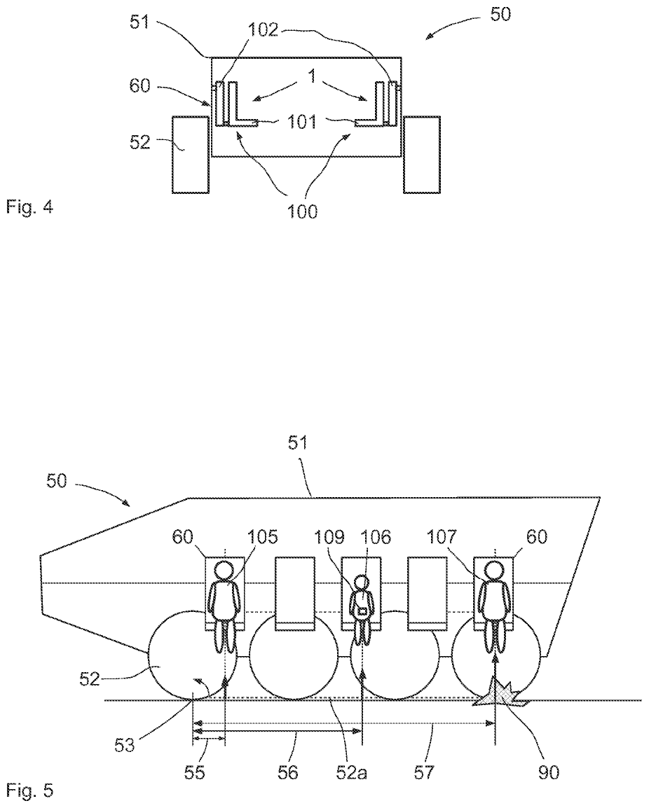

FIG. 4 a simplistic cross section of a vehicle with assemblies according to the invention for protecting passengers from explosions;

FIG. 5 a simplistic longitudinal section of a vehicle with assemblies according to the invention for protecting passengers from explosions;

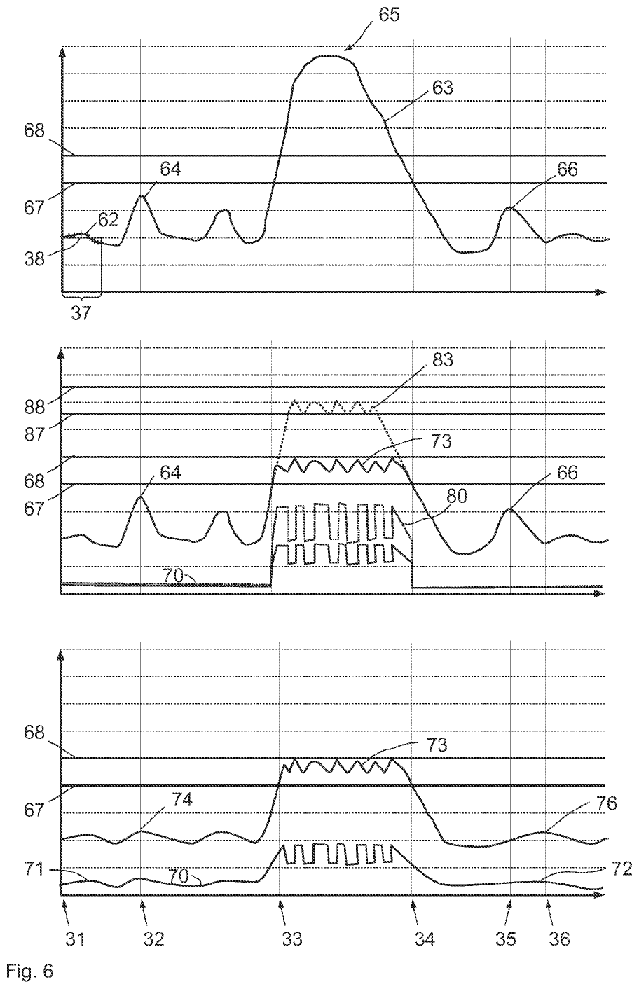

FIG. 6 the time curve of a load acting in a mine explosion, illustrating an undampened curve, a curve without a comfort function, and a curve with a comfort function.

FIG. 1 shows a schematic perspective view of an assembly 1 according to the invention. The assembly comprises an absorber cylinder 5, on one end of which an attachment device 3, and on the other end of which, a retaining device 4 is provided. The retaining device 4 and the attachment device 3 each have two laterally protruding arms, with a preloading spring 43 of a preloading device or a resetting device 23 placed on both of them, in order to transfer the assembly 1 after an overload event 65 to the resting state 40, which is also shown in FIG. 1. In other configurations the assembly 1 may show only one laterally protruding arm, or none.

The assembly 1 is provided to absorb energy or to damp relative movements between the attachment device 3 and the retaining device 4. For such purpose, the retaining device 4 is connected with the piston device 6 of the energy absorber 2, while the attachment device 3 is securely connected with the absorber cylinder 5. At the upper end, an end cap 39 can be seen that closes off from the outside and delimits the second chamber of the absorber chamber 9 concealed in the interior. The assembly 1 is in particular inserted in a loading unit 100 between a receiving unit 101 and a carrier device 102 (see FIG. 3 or 4).

FIG. 2 shows a front view of the assembly 1. A symmetry axis 30 extends centrally through the absorber cylinder 5, the section in FIG. 3 running through said symmetry axis. FIG. 2 schematically illustrates the seat assembly 21 and the seating surface 21a, on which a person 105 may be seated. Articles 104, animals or other objects 103 may be transported and during transport, may be protected against e.g. mine explosions.

It is also possible for the seat assembly 21 to be attached to a speedboat, damping shocks e.g. from waves. In the case of speedboats, a very strong wave may occur e.g. once a minute, which then causes a considerably higher load than do the other waves. Then it is highly advantageous for an energy absorber to be provided for damping overload events. In this case the overload event is a correspondingly high wave.

FIG. 3 shows a schematic section according to FIG. 2 in a resting state 40. The seat assembly 21 is also schematically shown, as a loading unit 100. The loading unit 100 has a receiving unit 101 or a seating surface 21a, on which an object 103 such as a person 105, e.g. a soldier in a personnel carrier, or on a speedboat or the like, can be seated.

In the interior of the absorber cylinder 5 one can recognize a section of the absorber piston 7 connected with the piston rod 8 of the piston device 6. The absorber piston 7 divides the absorber chamber 9 located in the interior of the absorber cylinder 5 into a first chamber 10 and a second chamber 11. The second chamber 11 is limited from the outside by the end cap 39 and in this case, is sealed airtight. The first chamber 10 is supported at its end by a guide bushing 45 and sealed with a seal 46.

In the resting state, the first chamber 10 is at least partially and in particular entirely filled with (at least one) absorber fluid 12. When an overload event 65 occurs, the piston rod 8 is retracted out of the absorber cylinder 5, so that the absorber fluid 12 in the first chamber 10 passes through the absorber valve 13 with the absorber channel 14 in the absorber piston 7, and into the second chamber 11. In the resting state, the second chamber 11 can already be filled to a certain extent with absorber fluid 12. Alternately, when in the resting state the second chamber 11 may be hardly or not at all filled with absorber fluid 12 but only with air or another compressible gas or medium. It is also conceivable for the second chamber 11 to be filled with an incompressible medium, which is irreversibly ejected outwardly in an overload event 65 through an overload valve, not visible.

It is clearly visible that the piston rod 8 has a (very) large diameter relative to the diameter of the absorber cylinder, so that only a relatively small annular gap for the first chamber 10 remains around the piston rod. Thus, when the absorber piston 7 is extended, only a relatively small volume of absorber fluid 12 is displaced from the first chamber 10. Therefore, the flow velocities of the absorber fluid 12 in the absorber channel 14 remain low even during overload events 65 caused by explosions, so that the length of the absorber piston 7 is sufficient to influence the flow of the absorber fluid as desired, using the magnetic field of the electric coil 16 as the field generation device 16.

The absorber fluid 12 used is in particular a magnetorheological fluid, which can be influenced by the magnetic field of the electric coil 16. The coil shows coils wound transverse to the axis of symmetry 30. A permanent magnet 16a may be provided which generates a basic magnetic field that is modulated by the coil 16. Then, a permanent magnet 16a will always set a minimum damping which may be increased or decreased by an actively controlled magnetic field of the coil 16.

When the flowing fluid respectively absorber fluid 12 passes from the first chamber 10 into the second chamber 11, the absorber fluid 12 is diverted towards the interior by the radial flow apertures 44 extending radially obliquely towards the interior from the outside. This means that the flow channel or absorber channel 14 is radially placed further inwardly than is the first chamber 10. This enables the effective use of the interior of the absorber piston 7 for generating the required magnetic field and for the absorber channel 14, shown in hachure.

The piston rod 8 is shown here with a considerably greater thickness than would be necessary for ensuring stability. Therefore, a hollow space 22 may be provided in the piston rod 8, which is shown here as a blind hole. The blind hole 22 extends from the end 26 opposite the piston into the piston rod 8. The hollow space 22 can extend up to just in front of the absorber piston 7, so that the length of the hollow space 22 extends over three-quarters or more of the length of the piston rod 8 up to the absorber piston 7. The hollow space 22 can be used accordingly. The control device 48 and an energy storage device 47 are disposed in the interior of this hollow space 22. The control device 48 is connected to the electric coil 16, in order to control it. Moreover, the control device 48 is connected to a sensor device 61 in order to absorb and process the loads on the loading unit 100 configured as a seat assembly 21.

The energy storage device 47 ensures that even in the event of a loss of power on board the means of transport, or at least for a defined time period after loss of power, the assembly 1 provides a sufficient amount of energy to control the energy absorber 2. The energy storage device can be a capacitor or a rechargeable battery. It is also possible to provide no hollow space and/or no energy storage device.

The absorber piston 7 not only separates the first chamber 10 from the second chamber 11, but also forms a flow valve 13, which can be controlled by means of the control device 48.

The sensor device 61 may be accommodated in or on the seating surface 21a. Above the sensor device 61, a cushion 21b may be disposed. The sensor device 61 on the seating surface 21a advantageously captures the load respectively load value of the transported person 105 or of a transported article 104. The load on the object 103 respectively the load value is conveniently measured directly. A cushioning effect of the cushion 21b is taken into account and does not need to be determined separately.

This also applies, to a reduced but still advantageous degree, if the sensor device 61 is disposed between the bracket 59 of the seat assembly 21 and the bracket 58 on the transport means. Also in this case, a useful measure of the load on the transported person 105 is captured.

The sensor device 61 is also employed to determine and in particular to capture the measure of the weight of the transported object 103 or the transported person 105. When a person 105 sits on the seat assembly 21, the sensor device 61 is subjected to a static load. The measurement values allow to derive the measure of the weight of the person 105. It is thus possible to set an individual threshold value for a load on a transported person 105 respectively a transported object 103.

In simple cases, a maximum load or a threshold value for a loading unit 100 may be set in proportion to the weight of the person intended for transport. A heavier person showing a similar physical state typically has more stable bones. In the case of militarily trained task forces one can basically assume a similar or comparable physical state. This is why it can be assumed that a heavier person has a more stable bone structure and can withstand higher loads without damage or injuries. In order to supply an appropriate reserve of the vertical absorber lift, it is therefore advantageous, in the case of an overload event 65 such as a mine explosion, to subject a heavier person to higher loads than a more lightweight person. This may be provided by way of individually sensing the weight of the transported persons. A separate sensor is not required. The sensor device 61 may be used, which is in particular configured as a weighing cell or an expansion measuring strip or the like. It is also possible to use various sensor devices 61 or various sensors of a sensor device 61 to determine the measure of the weight of the transported person 105.

For a typical person showing e.g. 75 kg weight, a specific threshold value of the load may be predefined. Percentages of deviations for heavier or lighter persons may be set.

Capturing a measure of the weight of a person intended for transport or an object intended for transport is preferably captured as the person 105 concerned sits down on the seating surface of the seat assembly 21. It is possible to capture a measure of the weight when activating or starting the assembly 1. Alternately it is possible to determine a time average when starting or after starting respectively activating the assembly 1, on which the computation is then based. A time average increases the accuracy, in particular in the case of a static average, before the transport means is moving. However, a moving transport means also allows to derive a time average for the weight of a person intended for transport, and to provide a sufficiently precise result.

FIG. 3 furthermore shows an identification unit 109 on the person 103 or on the alternative article 104 intended for transport, which is shown in broken lines. The identification unit 109 preferably includes a memory 110, containing details on the type 111 and the characteristics of the person 103 and his/her individual threshold value. The memory 110 may for example contain the specification of a 10% increase of the individual threshold value. Then it is possible and preferred to determine a weight-related threshold value for the transported person 105, which is then increased, taking into account the individual 10% adaptation. Accordingly it is also possible to decrease the threshold value. Alternately it is possible to file in the memory 110 a fixed threshold value which is set independently of the weight of the person 105 intended for transport.

Alternately it is possible for the memory 110 of the identification unit 109 to contain further data about the type 111, such as the gender, the age or the physical state. This data may also be captured and taken into account for determining an individual threshold value.

Transmitting the content of the memory 110 of the identification unit 109 to the assembly 1 may be wire-bound and/or wireless. Various methods may be used for the transmission. Transmission may for example be by means of RFID. It is possible to perform a transmission in that the person intended for transport touches or actuates a dedicated switch on the assembly 1, so as to ensure the association.

FIGS. 4 and 5 show schematic, transverse and longitudinal sections of a means of transport 50, such as a personnel carrier, provided with assemblies 1 according to the invention, in order to protect the passengers during explosions. The means of transport 50 has a body 51, with mine blast protection seats 60 attached thereto as assemblies 1. The vehicle 50 can be driven using wheels, presently with tires 52, although it may partially or completely be provided with chains. In an overload event 65, such as an explosion, the vehicle 50 is catapulted into the air, wherein a damped movement occurs of the loading unit 100 of the assemblies 1, identified here as a seat assembly 21, in order to protect the persons seated thereon from permanent damage.

FIG. 5 shows a schematic longitudinal section of a transport means 50 such as a personnel carrier, provided with a vehicle body 51 and a number of wheels 52, or also a chain drive. An optional chain drive instead of or in addition to wheels 52 is schematically shown by a chain 52a, in broken lines. In the interior, a number of seat assemblies 21 is disposed on which a number of persons 105-107 can be transported.

In the rear portion of the personnel carrier 50, an exploding mine 90 is shown simplistically. The rear portion of the personnel carrier 50 is thus lifted. A pivot point 53 is for example located at the foremost wheel 52. The distances 55, 56 and 57 from the front pivot point 53 results in different accelerations and thus different forces acting on the persons 105, 106 and 107. Due to the considerably shorter distance 55 from the pivot point 53, the load (load value) on the person 105 is considerably less than is the load on the person 107 multiple times distant 57 from the pivot point. Due to the shorter distance 56, the load on the person 106 at the distance 56 is smaller, compared to the distance 57.

In this case the transported person 106 is smaller and weighs less than the other persons 105 and 107. This causes a reduction of the force acting on the person 106. At the same time, however, it must be considered that a smaller person 106 tends to show less stability under load, so that the maximum load on the person 106 is typically less than that of a larger and heavier person 107. At the same time, given identical acting accelerations, the load decreases with the weight decreasing.

The individual capturing of one measure each of the weight of the persons 105 to 107 allows to obtain individually matched damping of the assemblies 1 of each of the seat assemblies 21.

This will reliably provide for each of the persons 105 to 107 that the admissible individual threshold values 68 for the load are not exceeded. The damping of the energy absorber 2 is set via the control device 48 so that at all times, even in an overload event 65, the load or the load value never exceeds the pertaining load limit 68.

The measurement values of the loads occurring are captured at periodic intervals, and the current intensity in the energy absorber 2 is set by way of the measurement values obtained, taking into account the individual load limits 68, so as to not overshoot what are the permissible maximum loads 68. Each measurement is preferably immediately followed by adjusting the current intensity so as to adapt the pertaining damping. It is also possible to first capture a number of measurement values to obtain a precise measurement signal, and to then periodically adapt the current intensity. For example, measurements may be taken once in every 0.1 or 0.5 milliseconds, while the current intensity is set once in every 1, 2, or 5 or 10 milliseconds.

FIG. 6 shows over the time progression three conceivable progressions of the time curve of the load, in an overload event 65 such as the explosion of the mine 90 in FIG. 5.

The uppermost graph shows the time curve of the load including an overload event 65. This progression would ensue in the absence of any damping. At the beginning respectively when starting the assembly, measurement values 62 may be recorded by the sensor device 61 from the time 31 for a time interval 37, and be used for averaging to determine the measure of the weight of a transported person 105. The mean value 38 derived from the measurement values serves to set a threshold value 68 for the load on the person 105 intended for transport.

The center graph shows the time curve involving an overload damping. As the measurement values 62 exceed an overload event threshold 67, the control device 48 detects an overload event. An appropriate response can be performed. Alternatively, an overload event is detected as the shear pin 42 shears off. At any rate, (no later than) upon detection of an overload event will the energy absorber 2 be activated, even if no comfort function at all is incorporated in the assembly 1. This means that shocks beneath the overload event threshold 67 are transmitted undampened to the seat assembly 21. This applies in the center graph to the shocks 64 or 66, which are transmitted undampened.

The center graph of FIG. 6 shows two different load progressions 73 and 83 for persons with different weights, the person at the load progression 83 showing a larger individual weight than does the person at the load progression 73. The different weights of each of the persons result in different load limits 67 and 87. For the more lightweight person, the overload event threshold 67 and a maximum load 68 ensue, while for the heavier person, a considerably higher overload event threshold 87 and a considerably higher load limit 88 ensue.

In the center graph in FIG. 6, shocks beneath the individual overload event thresholds 67 or 87 are transmitted undampened, while above the exceeded overload event thresholds 67 or 87, a suitable electric current progression 70 (solid line) respectively 80 (broken line) is set, so as to retain what is the actual load respectively the actual load value beneath the pertaining load limits 68 respectively 88. The indicated regulating fluctuations may occur, which are presently only shown for illustration purposes with the regulating fluctuations shown. Depending on the regulating speed and regulating resolution, a completely smooth and continuous curve may show.

At any rate, the load occurring for each of the transported persons 105 (106 . . . 107) is determined at periodic intervals by way of the actual load with the measurement values 62. In dependence on the level of the measurement values 62 respectively the pertaining load, a suitable current intensity is set to provide for proper damping by the energy absorber 2. Ultimately, load progressions 73 or 83 may ensue. Different or identical current intensity progressions 70, 80 may ensue.

Typically, different progressions of the current intensity 70, 80 will ensue for different persons.

The bottom graph in FIG. 6 illustrates a load progression 73 for the person 105 in the center graph of FIG. 6, wherein comfort damping 71 has been additionally activated.

An overload event 65 will in turn only occur at the time 33, as the overload event threshold 67 has been exceeded. Then, damping at the energy absorber 2 takes place in the overload mode, with pertaining current intensities 70 being set for the actual load progression 73 to remain beneath the load limit 68.

In the third graph at the bottom in FIG. 6, for example a proportion of 20% of the total vertical lift of the energy absorber 2 may be provided for the comfort function, by means of which single shocks 64 and 66 can be effectively dampened. Not only the strength of single hits 64 and 66 beneath the overload limit 67 can be clearly reduced, but more agreeable oscillation frequencies may be generated for the persons intended for transport to impose a reduced load on the persons' bodies. This may result in that a shock 66 originally occurring at the time 35, will only be perceived at the time 36 at a clearly reduced amplitude 76. Accordingly, in comfort damping, the range of the load progression beneath the overload event threshold 67 also shows an electric current progression clearly differing from 0.

In all the configurations it is possible to set the comfort damping harder as the end of the provided range for the comfort damping 71 approaches.

All the configurations of the invention also provide for setting a still harder damping with increasing approach and/or shortly in front of the limit of the vertical lift (e.g. remaining lift <5% or <10%) of the energy absorber. This is conceivable even if the individual load limit should be exceeded (a little, e.g. <10%), so as to in particular prevent bottoming out. Bottoming out might cause the generated load to increase more intensely, which is why moderately exceeding the individual load limit may show less damaging effects, or permanently damaging effects may even be entirely prevented. Such an increase may be realized individually.

In all the configurations it is preferred to at least partially store the load progressions ensuing in operation and the measured measurement values. This allows evaluation at a later time and/or improvements to controlling by way of the evaluated data.

It is also possible to store for example the bone structure of a person intended for transport, as a parameter in the memory 110 of the identification unit 109 as data, and take it into account when determining an individual load limit 68.

List of Reference Numerals:

| | |
|---|---|
| 1 | assembly |
| 2 | energy absorber attachment device |
| 4 | retaining device |
| 5 | absorber cylinder |
| 6 | piston device |
| 7 | absorber piston |
| 8 | piston rod |
| 9 | absorber chamber |
| 10 | first chamber |
| 11 | second chamber |
| 12 | absorber fluid |
| 13 | absorber valve |
| 14 | absorber channel |
| 16 | electric coil |
| 16a | permanent magnet |
| 21 | seat assembly |
| 21a | seating surface |
| 21b | cushion |
| 22 | hollow space |
| 23 | resetting device |
| 26 | end |
| 30 | axis of symmetry |
| 31-36 | time |
| 37 | time interval |
| 38 | mean value |
| 39 | end cap |
| 40 | resting state |
| 42 | shear device |
| 43 | suspension device |
| 44 | flow aperture |
| 45 | guide bushing |
| 46 | seal |
| 47 | energy storage device |
| 48 | control device |
| 50 | means of transport |
| 51 | body |
| 52 | tire |
| 52a | chain |
| 53 | pivot point |
| 55-57 | distance |
| 58 | bracket vehicle |
| 59 | bracket seat |
| 60 | mine protection seat |
| 61 | sensor device |
| 62 | measurement values |
| 63 | load progression |
| 64 | shock |
| 65 | overload event |
| 66 | shock |
| 67 | overload event threshold |
| 68 | maximum loading, load limit, threshold value |
| 70 | electric current progression |
| 71 | comfort damping |
| 73 | load progression |
| 74, 76 | amplitude |
| 80 | electric current progression |
| 83 | load progression |
| 87 | overload event threshold |
| 88 | load limit |
| 90 | mine |
| 100 | loading unit |
| 101 | receiving unit |
| 102 | carrier device |
| 103 | object |
| 104 | article |
| 105 | person |
| 106 | person |
| 107 | person |
| 109 | identification unit |
| 110 | memory |
| 111 | type |

1-23. (canceled)

24. A method for absorbing energy during an overload event to reduce loads on an object being transported on a loading unit, the method comprising:
providing an energy absorber that is configured for absorbing energy during an overload event, wherein the overload event would introduce a degree of energy that, without an energy absorber, would probably or overwhelmingly likely cause damage to the object, and wherein the energy absorber is configured, during the overload event, to reduce a resulting load on the object by energy absorption with the energy absorber;
using a sensor device to periodically acquire measurement values of a present state of the loading unit;
using a control device to detect an overload event from the measurement values acquired by the sensor device, determining a measure of a weight of the object, and deriving a threshold value for a load on the object from the measure of the weight; and
upon detecting the overload event, controlling a damping of the energy absorber to maintain the load on the object below the threshold value.

25. The method according to claim 24, which comprises, after detecting the overload event, periodically adapting the damping of the energy absorber by way of the periodically captured measurement values.

26. The method according to claim 24, which comprises causing the control device to periodically derive characteristic parameters for a load on the loading unit from the measurement values.

27. The method according to claim 24, which comprises providing the loading unit with a shear device which shears off as the load acting on the loading unit exceeds an overload event threshold, wherein the control device detects an overload event when shearing of the shear device is detected.

28. The method according to claim 24, which comprises detecting an overload event with the control device when a characteristic value exceeds an overload event threshold.

29. The method according to claim 24, which comprises specifying the overload event threshold in dependence on the threshold value.

30. The method according to claim 24, which comprises determining the measure of the weight of the object intended for transport from the load on the loading unit in a state of rest.

31. The method according to claim 24, which comprises determining the measure of the weight of the object intended for transport from a time average of the load on the loading unit.

32. The method according to claim 31, which comprises determining the load on the loading unit immediately upon activation.

33. The method according to claim 24, which comprises determining a type of the object intended for transport.

34. The method according to claim 33, which comprises detecting an identification unit of the object intended for transport.

35. The method according to claim 34, which comprises reading out a memory of the identification unit of the object intended for transport.

36. The method according to claim 24, which comprises performing a comfort damping process for a portion of a vertical lift of the energy absorber.

37. The method according to claim 24, wherein the overload event threshold and/or a maximum load of the object intended for transport is variable.

38. The method according to claim 37, which comprises storing a presetting for a maximum load in an identification unit associated with the object intended for transport.

39. The method according to claim 37, wherein the maximum load is dependent on a gender and/or an age of a person being the object intended for transport.

40. A method for absorbing energy during an overload event in order to reduce loads on an object being transported on a loading unit, the method comprising:
providing an energy absorber configured for absorbing energy at least during a single overload event, wherein the overload event introduces such a high degree of energy that, without an energy absorber, would render damage to the object probable or overwhelmingly likely, the energy absorber, during the overload event, reducing a resulting load on the object by way of energy absorption with the energy absorber;
periodically acquiring measurement values of a present state of the loading unit with a sensor device;
determining a measure of the load on the object intended for transport and detecting an overload event from the captured measurement values with a control device; and
upon detecting the overload event, controlling a damping of the energy absorber such that the load on the object intended for transport remains beneath a threshold value.

41. An assembly, comprising:
a loading unit for transporting objects and an energy absorber for absorbing energy in an overload event to reduce loads acting on an object being transported on said loading unit;
said energy absorber being configured to absorb energy in a single or a repeated overload event that involves an energy input that is so high that, absent an energy absorber, damage to the object is possible or highly probable, so as to reduce resulting loads acting on the object in the overload event by energy absorption by way of said energy absorber;
a control device and at least one sensor device for capturing measurement values about a present state of said loading unit and said energy absorber;
said control device being configured to control said energy absorber by way of the measurement values, and to detect an overload event from the measurement values captured by said at least one sensor device;
said control device being configured to determine a measure of a weight of the object intended for transport, and to determine from the measure of the weight, a threshold value for a load on the object intended for transport; and
said control device being configured, upon detecting the overload event, to control a damping of the energy absorber to maintain the load on the object intended for transport beneath the threshold value.

42. The assembly according to claim 41, wherein said sensor device is attached to a dampened part of the assembly.

43. The assembly according to claim 41, wherein said sensor device comprises at least one sensor selected from the group consisting of a weighing cell, a load transducer, and an expansion measuring strip.

44. The assembly according to claim 41, wherein said energy absorber comprises at least one absorber valve with a damping behavior controlled by a strength of an applied magnetic field.

45. The assembly according to claim 41, wherein said loading unit comprises a shear device which shears off as a load acting on the loading unit exceeds a predetermined amount.

46. The assembly according to claim 41, wherein said loading unit is a seat device of a transport vehicle, said seat device comprises a seat and a seat frame supporting said seat, and wherein said energy absorber is disposed between said seat and said seat frame.
